(19) United States
(12) Patent Application Publication
(10) Pub. No.: US 2026/0318392 A1
(43) Pub. Date: Oct. 15, 2026

(54) Transmission and Propulsion System for a Motor Vehicle

(71) Applicant: ZF Friedrichshafen AG, Friedrichshafen (DE)

(72) Inventors: Stefan Beck, Eriskirch (DE); Matthias Reisch, Ravensburg (DE)

(21) Appl. No.: 19/483,754

(22) PCT Filed: Apr. 25, 2024
(86) PCT No.: PCT/EP2024/061330

§ 371 Date: Nov. 12, 2025

(30) Foreign Application Priority Data
May 12, 2023 (DE) 102023204423.4

(51) Int. Cl. F16H 37/08; B60K 1/00

(52) U.S. Cl. CPC F16H 37/082; B60K 1/00; B60K 2001/001; F16H 2200/0021; F16H 2200/2007; F16H 2200/2035

(57) ABSTRACT

The invention relates to a transmission for a motor vehicle comprising
a first planetary gear set (P1) and a second planetary gear set (P2), wherein each of the two planetary gear sets (P1, P2) comprising a first element (E11, E21), a second element (E12, E22) and a third element (E13, E23),
a drive shaft (WAn) for connecting the transmission (1) to a driving machine (2) of the motor vehicle (100),
a first output shaft (WAb1) and a second output shaft (WAb2) for respectively connecting the transmission (1) to a wheel (R1, R2) of the motor vehicle (100),
a coupling shaft (W1) which connects the first element (E11) of the first planetary gear set (P1) and the first element (E21) of the second planetary gear set (P2) in a rotationally fixed manner,
wherein the drive shaft (WAn) is connected in a rotationally fixed manner to the second element (E12) of the first planetary gear set (P1),
wherein the first output shaft (WAb1) is connected in a rotationally fixed manner to the third element (E13) of the first planetary gear set (P1),
wherein the second output shaft (WAb2) is connected in a rotationally fixed manner to the second element (E22) of the second planetary gear set (P2),
wherein the third element (E23) of the second planetary gear set (P2) is connected in a rotationally fixed manner to a stationary component.

The invention relates to a transmission for a motor vehicle with at least two planetary gear sets. Furthermore, the invention relates to a driving device with such a transmission as well as a motor vehicle with such a driving device.

For example, DE 10 2013 222 233 A1 discloses an epicyclic gear transmission for branching the driving power present at a power input to a first and to a second power output, with a superposition gear stage, which comprises a first sun gear, a first planetary gear set, a first planet carrier and a first ring gear, and a reversing gear stage, which comprises a second sun gear, a second planetary gear set, a second planet carrier and a second ring gear. The superposition gear stage and the reversing gear stage are kinematically coupled. The epicyclic gear transmission is configured such that it can be operated in a first and a second shifting state. The first and the second shifting state differ with regard to the overall gear ratio resulting between the power input and the power outputs.

The object of the present invention consists in providing an alternative transmission, which in particular comprises one or two transmission gear ratios and an improved efficiency. In particular, the transmission should be configured to be lightweight, compact and cost-effective. Furthermore, the transmission should realize both a transmission function, that is a torque conversion, as well as a differential function, that is a torque distribution. These objects are achieved by a transmission with the features of claim 1 and claim 2. Advantageous embodiments are the subject matter of the dependent claims, the following description as well as the figures.

A transmission according to the invention for a motor vehicle comprises
a first planetary gear set and a second planetary gear set, wherein each of the two planetary gear sets comprising a first element, a second element and a third element,
a drive shaft for connecting the transmission to a driving machine of the motor vehicle,
a first output shaft and a second output shaft for respectively connecting the transmission to a wheel of the motor vehicle,
a coupling shaft which connects the first element of the first planetary gear set and the first element of the second planetary gear set in a rotationally fixed manner,
wherein the drive shaft is connected in a rotationally fixed manner to the second element of the first planetary gear set,
wherein the first output shaft is connected in a rotationally fixed manner to the third element of the first planetary gear set,
wherein the second output shaft is connected in a rotationally fixed manner to the second element of the second planetary gear set,
wherein the third element of the second planetary gear set is connected in a rotationally fixed manner to a stationary component.

Such a transmission, which comprises only one transmission gear ratio, is shown for example in FIG. 2. Furthermore, the transmission has a good efficiency and is configured to be lightweight, compact and cost-effective.

A further transmission for a motor vehicle according to the invention comprises
a first planetary gear set and a second planetary gear set, wherein each of the two planetary gear sets comprising a first element, a second element and a third element,
a drive shaft for connecting the transmission to a driving machine of the motor vehicle,
a first output shaft and a second output shaft for respectively connecting the transmission to a wheel of the motor vehicle,
a coupling shaft which connects the first element of the first planetary gear set and the first element of the second planetary gear set in a rotationally fixed manner,
a first switching element and a second switching element for switching of two different transmission ratios,
wherein the drive shaft is connected in a rotationally fixed manner to the second element of the first planetary gear set,
wherein the first output shaft is connected in a rotationally fixed manner to the third element of the first planetary gear set,
wherein the second output shaft is connected in a rotationally fixed manner to the second element of the second planetary gear set,
wherein the third element of the second planetary gear set is connectable in a rotationally fixed manner to a stationary component via the first switching element for setting a first transmission ratio,
wherein the third element of the second planetary gear set is connectable in a rotationally fixed manner at least indirectly to the drive shaft via the second switching element for setting a second transmission ratio.

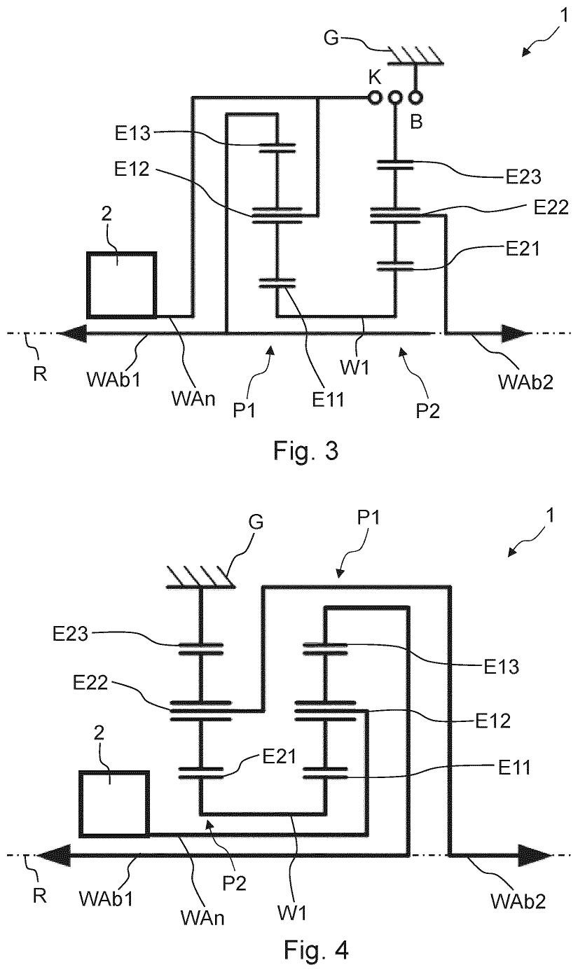

Such a transmission, which comprises two transmission ratios, is shown for example in FIG. 3. Furthermore, the transmission has a good efficiency and is configured to be lightweight, compact and cost-effective.

A “connection” of a device or of an element to the transmission is understood to mean that the transmission, in particular the corresponding shaft of the transmission, is connected either directly, for example in a rotationally fixed manner, to the device or to the element, or indirectly, for example via at least one further component, in particular via at least one further shaft or a further gear. If two shafts are connected to one another in a rotationally fixed manner, they rotate together in a direction of rotation at a rotational speed. In particular, a connection may also take place via a switching element, whereby a driving coupling and decoupling of the device or of the element to the corresponding shaft of the transmission is possible.

A “shaft” is not to be understood exclusively as a for example cylindrical, rotatably mounted transmission element for transmitting torques, but rather is also to be understood as general connecting elements which connect individual components or elements to one another, in particular connecting elements which connect a plurality of elements to one another in a rotationally fixed manner. Two shafts connected to one another in a rotationally fixed manner may be configured in one piece.

A “stationary component” is to be understood as a non-rotating component of the transmission. For example, the stationary component may be configured as a housing or housing section of the transmission. Alternatively, the stationary component may be configured as a shaft fixed to the housing.

A “switching element” is to be understood as a switchable device which, in a closed state, connects two shafts or one shaft and a stationary component to one another in a rotationally fixed manner and, in an open state, decouples the two shafts or the shaft and the stationary component from one another. Two shafts may then rotate relative to one another. In an actuated state, the switching element is closed. For example, the switching element may be configured as a positively locking switching element. In particular, the positively locking switching element is a dog clutch. The efficiency of the transmission due to reduced drag losses may be increased by positively locking switching elements. In particular, positively locking switching elements are configured to be more compact and optimized in terms of efficiency and have a cost advantage over frictionally locking switching elements. Alternatively, the switching element may be configured as a frictionally locking switching element. A frictionally locking switching element permits powershifts. For example, a frictionally locking switching element may comprise one or more friction surfaces acting in parallel. Alternatively, the frictionally locking switching element may comprise one or more friction surfaces of conical configuration. In particular, the frictionally locking switching element may be configured as a multiplate clutch. preferably, the switching element is actuated by an actuator. For example, the first switching element and the second switching element may be configured as a double switching element and may be actuated by means of a single actuator.

When the first switching element is closed and the second switching element is open, a first transmission ratio is set. This corresponds to a first gear stage or a first gear. When the first switching element is open and the second switching element is closed, a second transmission ratio is set. This corresponds to a second gear stage or a second gear. A transmission comprising the first and second switching elements thus comprises precisely two gears which are shifted by means of the two switching elements.

According to a preferred embodiment, the first element of the respective planetary gear set is configured as a sun gear, wherein the second element of the respective planetary gear set is configured as a planet carrier, wherein the third element of the respective planetary gear set is configured as a ring gear. A plurality of planet gears which are in meshing engagement with the respective sun gear and the respective ring gear of the respective planetary gear set are rotatably mounted on the planet carrier. Thus, according to this preferred embodiment, both the first planetary gear set and the second planetary gear set are configured as a minus planetary gear set.

A planetary gear set comprising three elements may transmit torque from any one of the three elements to the two other elements. In this case, the torques at the three elements of the planetary gear set behave proportionally to one another. The sum of all torques is always equal to zero taking into consideration the signs.

In the counting method of the elements used here, the second element of the respective planetary gear set carries the highest torque in terms of absolute value, namely the sum torque of the respective planetary gear set. In the case of a conventional minus planetary gear set, this is the planet carrier.

The first element of the respective planetary gear set preferably carries the smallest torque in terms of absolute value. The sign of the torque at the first element of the respective planetary gear set is inverse to the sign of the torque at the second element of the respective planetary gear set. In the case of a conventional minus planetary gear set, the first element is the sun gear.

The third element of the respective planetary gear set preferably carries the middle torque in terms of absolute value. The sign of the torque at the third element of the respective planetary gear set is inverse to the sign of the torque at the second element of the respective planetary gear set and identical to the sign of the torque at the first element of the respective planetary gear set. In the case of a conventional minus planetary gear set, this is the ring gear.

For example, the driving machine is configured as an electric machine which can be operated as a drive motor for driving the motor vehicle and as a generator for recuperating electrical energy. For this purpose, the electric machine is electrically connected to an electrical energy store. The electric machine comprises a rotor and a stator, wherein the rotor is connected in a rotationally fixed manner to a rotor shaft. The rotor shaft of the electric machine is connected at least indirectly or directly to the drive shaft. For example, the rotor shaft of the electric machine may be connected to the drive shaft via at least one further shaft, via a plurality of gears and/or via a traction means. For example, the rotor shaft of the electric machine may be connected to the drive shaft via a transmission stage, such that the transmission stage is arranged in the power flow between the driving machine and the drive shaft. The electric machine may be arranged on a common rotation axis with the transmission. Alternatively, the electric machine may be configured axially parallel to the transmission. Furthermore, the driving machine may alternatively be configured as an internal combustion engine with a crankshaft.

According to a preferred embodiment, the connection of the driving machine takes place axially between the first planetary gear set and the second planetary gear set. Thus, the first planetary gear set and the second planetary gear set are not arranged axially adjacent to one another, but rather are respectively arranged axially adjacent to the connection of the driving machine, i.e. spaced apart from one another by the connection of the driving machine. According to a preferred embodiment, the first planetary gear set and the second planetary gear set are arranged axially adjacent to one another, i.e. next to one another, and the connection of the driving machine takes place laterally next to one of the planetary gear sets. Depending on design boundary conditions, the one arrangement variant may be advantageous with respect to the other arrangement variant.

According to a preferred embodiment, the coupling shaft and/or one of the two output shafts is configured in one piece with the elements of the respective planetary gear set connected thereto. For example, the coupling shaft may be configured as a double sun gear.

In particular, at least one of the planetary gear sets of the transmission is configured either as a minus planetary gear set or as a plus planetary gear set and/or comprises stepped planetary gears. Thus, instead of being configured as a conventional minus planetary gear set, as was specified further above as a preferred embodiment, at least one of the planetary gear sets of the transmission according to the invention may be configured as a conventional plus planetary gear set, minus stepped planetary gear set, plus stepped planetary gear set with two sun gears or plus stepped planetary gear set with two ring gears. In this regard, reference is made to the embodiments according to FIGS. 16 to 19.

According to a preferred embodiment, at least one of the planetary gear sets is configured as a minus planetary gear set, wherein the first element of the respective planetary gear set is configured as a sun gear, wherein the second element of the respective planetary gear set is configured as a planet carrier, wherein the third element of the respective planetary gear set is configured as a ring gear. A plurality of planet gears which are in meshing engagement with the sun gear and the ring gear are rotatably mounted on the planet carrier.

Alternatively, at least one of the planetary gear sets may be configured as a minus stepped planetary gear set, wherein the planet carrier then guides a plurality of stepped planetary gears in a rotatably mounted manner. Each stepped planetary gear may comprise two gears connected to one another in a rotationally fixed manner. In other words, each stepped planetary gear may comprise two toothed portions which are connected to one another in a rotationally fixed manner and which have different diameters. One of the two toothed portions meshes with the sun gear and the other of the two toothed portions meshes with the ring gear. If the first element of the minus stepped planetary gear set is a sun gear, then the third element of the minus stepped planetary gear set is configured as a ring gear. If the first element of the minus stepped planetary gear set is a ring gear, then the third element of the minus stepped planetary gear set is configured as a sun gear. The second element of the minus stepped planetary gear set is configured as a planet carrier in both cases.

Alternatively, at least one of the planetary gear sets may be configured as a plus planetary gear set, wherein the first element of the respective planetary gear set is configured as a sun gear, wherein the third element of the respective planetary gear set is configured as a planet carrier, wherein the second element of the respective planetary gear set is configured as a ring gear. In the case of a plus planetary gear set, the planet carrier guides at least one planet gear pair in which the one planet gear is in toothed engagement with the inner sun gear and the other planet gear is in meshing engagement with the outer ring gear, and the planet gears mesh with one another.

Alternatively, at least one of the planetary gear sets may be configured as a plus stepped planetary gear set with two sun gears or as a plus stepped planetary gear set with two ring gears. In the case of a plus stepped planetary gear set with two sun gears, the first and the second element of the plus stepped planetary gear set are respectively configured as a sun gear, wherein the third element of the plus stepped planetary gear set is configured as a planet carrier. In the case of a plus stepped planetary gear set with two ring gears, the first and the second element of the plus stepped planetary gear set are respectively configured as a ring gear, wherein the third element of the plus stepped planetary gear set is configured as a planet carrier.

According to a preferred embodiment, a switching element for generating a blocking effect is arranged between the two output shafts. This switching element may be configured as a frictionally locking or positively locking switching element. For example, a positively locking switching element is configured as a dog clutch. The efficiency of the transmission may be increased due to reduced drag losses by a positively locking switching element. In particular, positively locking switching elements are configured to be more compact and optimized in terms of efficiency and have a cost advantage over frictionally locking switching elements. However, slip operation, i.e. a limited blocking effect under differential rotational speed, is not possible with positively locking switching elements. For example, a frictionally locking switching element may comprise a plurality of plates or at least one conical friction surface. In the case of a frictionally locking switching element, the latter may be actuated via an actuator or mechanically, in particular by using axial forces from helical toothings. An actuator may be arranged fixed to the housing or co-rotating. Frictionally locking switching element is a different term for a force locking switching element and thus describes the same component.

According to a preferred embodiment, a transmission stage is arranged in the power flow before the drive shaft. In other words, the transmission stage is arranged in the power flow between the driving machine and the drive shaft. Thus, the transmission stage is configured as a pre-transmission. The transmission stage may for example comprise two gears in meshing engagement with one another. For example, the transmission stage comprises one or more spur gear stages. For example, the transmission stage comprises an intermediate shaft. For example, the transmission stage comprises a bevel gear stage. The configuration of the transmission stage as a bevel gear stage is advantageous in particular in a longitudinally installed driving machine. For example, the transmission stage comprises a planetary gear set with a sun gear, a ring gear and a planet carrier on which a plurality of planet gears are rotatably mounted. For example, the transmission stage comprises a planetary gear set with a sun gear, a ring gear and a planet carrier on which a plurality of stepped planetary gears are rotatably mounted. By means of a transmission stage, higher transmission ratio may be achieved in the transmission.

For example, a transmission stage provided as a planetary gear set may be configured to be switchable and may comprise two switching elements. In other words, a first switching element for switching of a first gear and a second switching element for switching of a second gear are arranged in the power flow before the drive shaft. Together with a transmission stage provided as a planetary gear set, these two switching elements form a 2-gear assembly, which is connected before the two planetary gear sets of the transmission. The preceding planetary gear set may comprise, for example, the elements sun gear, ring gear and planet carrier. One of the elements of the preceding planetary gear set, for example the sun gear, may be connected in a rotationally fixed manner to the housing via the first switching element, such that a first transmission ratio is set. Thus, the first switching element may be configured as a brake. A “brake” is to be understood in this context as a switchable device which, in a closed state, connects a shaft of the preceding planetary gear set to a housing in a rotationally fixed manner, such that this shaft is then fixed in a stationary manner and thus prevented from rotating. In an open state of the switching element, the shaft is decoupled from the housing, whereby this shaft may rotate freely. The preceding planetary gear set may be blocked via the second switching element. In other words, two elements of the preceding planetary gear set, for example the sun gear and the ring gear, may be connected in a rotationally fixed manner, such that the preceding planetary gear set rotates in a block and comprises the transmission ratio 1. Both switching elements may be switched by a common actuator.

A driving device according to the invention comprises a driving machine and a transmission according to the invention. The driving machine is preferably configured as an electric machine. Alternatively, the driving machine is configured as an internal combustion engine. The driving machine may be arranged coaxially or axially parallel to the drive shaft of the transmission. The planetary gear sets are, for example, arranged coaxially to one another and to the drive shaft and thus rotate about a common rotation axis. Via the drive shaft, the driving power of the driving machine is fed into the transmission and distributed to the two output shafts, wherein the respective output shaft is drive-effectively connected to a respective drive wheel of a drive axle of the motor vehicle. The two planetary gear sets of the transmission form an integral differential. The transmission may be used as a transverse or longitudinal distributor differential.

A vehicle according to the invention comprises a driving device according to the invention. In particular, the vehicle is configured as an electric vehicle and comprises an electric drive axle with the driving device according to the invention. The vehicle according to the invention may be configured as a passenger car or utility vehicle. The above definitions as well as statements regarding technical effects, advantages and advantageous embodiments of the transmission according to the invention also apply analogously to the driving device according to the invention and to the vehicle according to the invention.

Advantageous embodiments of the invention, which are explained in the following, are shown in the drawings, wherein the same elements are provided with the same reference signs. In the drawings:

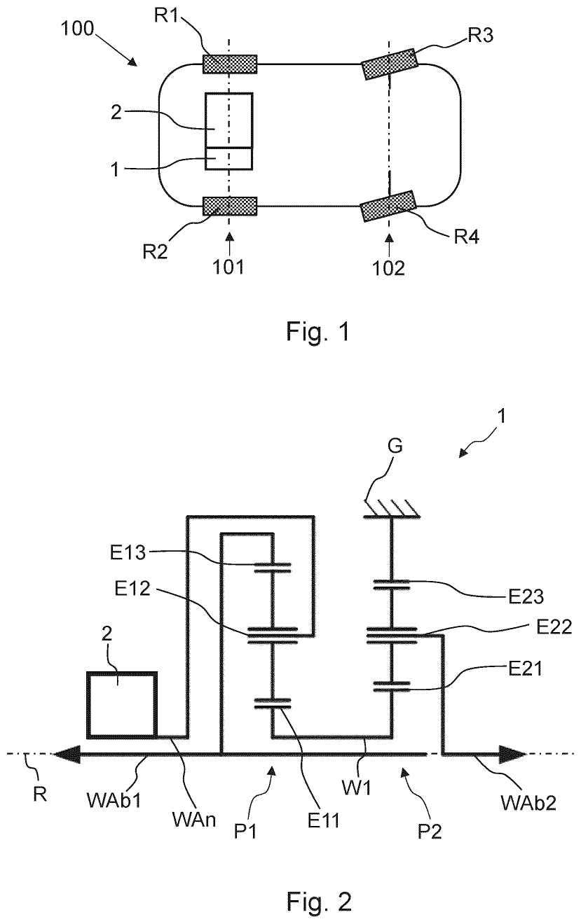

FIG. 1 shows a highly abstracted schematic view of a motor vehicle with a driving device according to the invention;

FIG. 2 shows a highly abstracted schematic view of a driving device according to the invention according to a first embodiment;

FIG. 3 shows a highly abstracted schematic view of a driving device according to the invention according to a second embodiment;

FIG. 4 shows a highly abstracted schematic view of a driving device according to the invention according to a third embodiment;

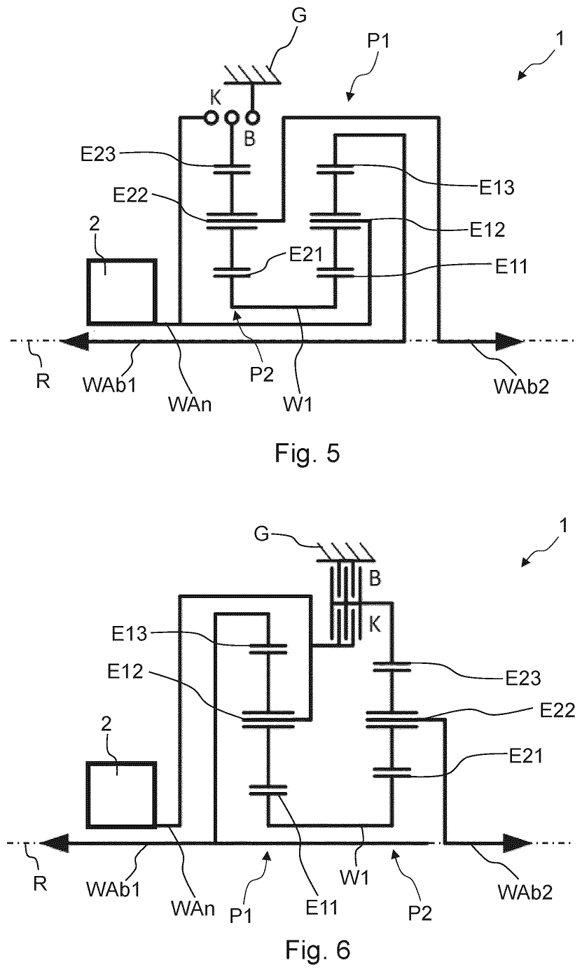

FIG. 5 shows a highly abstracted schematic view of a driving device according to the invention according to a fourth embodiment;

FIG. 6 shows a highly abstracted schematic view of a driving device according to the invention according to a fifth embodiment;

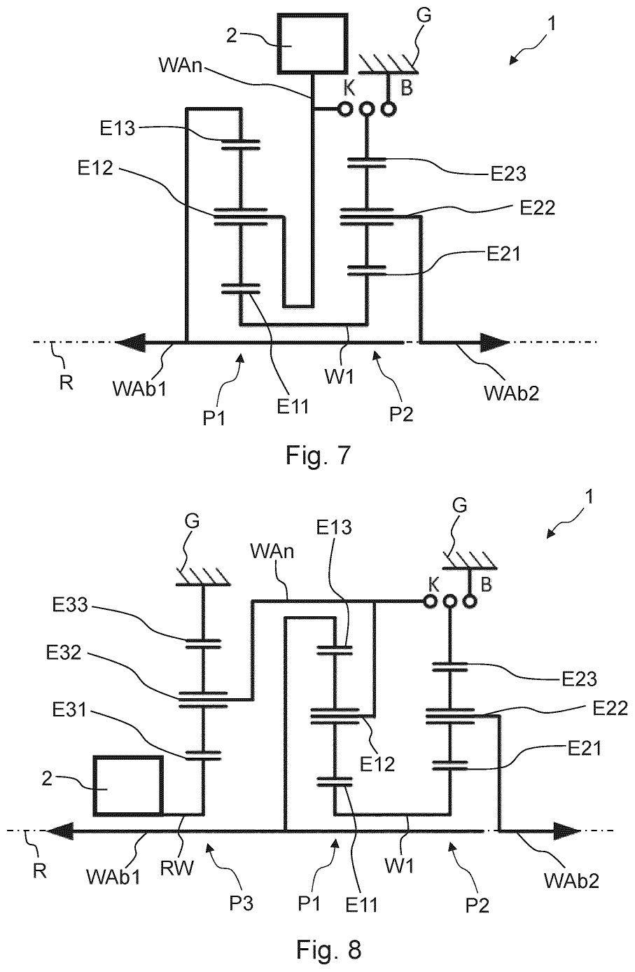

FIG. 7 shows a highly abstracted schematic view of a driving device according to the invention according to a sixth embodiment;

FIG. 8 shows a highly abstracted schematic view of a driving device according to the invention according to a seventh embodiment;

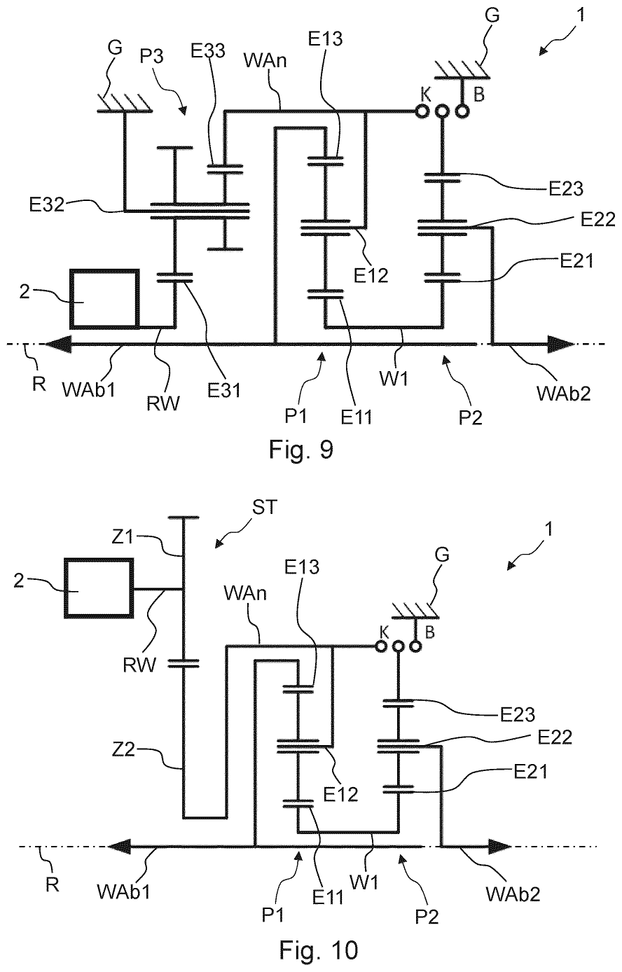

FIG. 9 shows a highly abstracted schematic view of a driving device according to the invention according to an eighth embodiment;

FIG. 10 shows a highly abstracted schematic view of a driving device according to the invention according to a ninth embodiment;

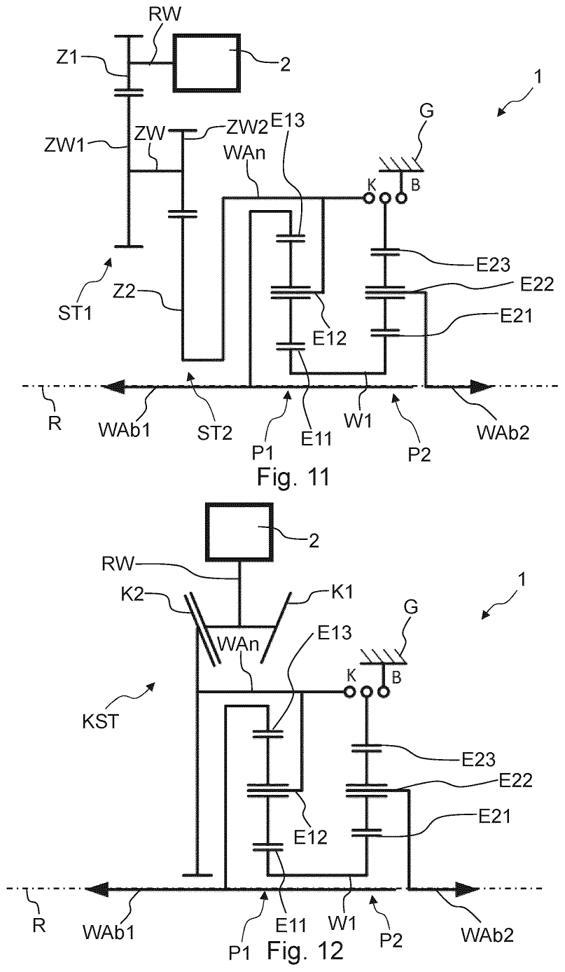

FIG. 11 shows a highly abstracted schematic view of a driving device according to the invention according to a tenth embodiment;

FIG. 12 shows a highly abstracted schematic view of a driving device according to the invention according to an eleventh embodiment;

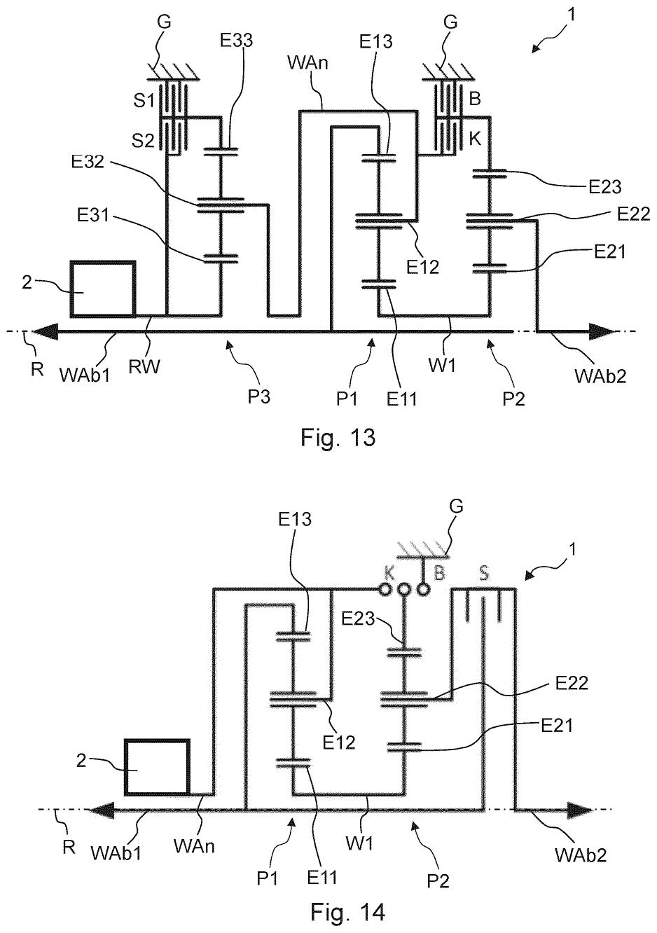

FIG. 13 shows a highly abstracted schematic view of a driving device according to the invention according to a twelfth embodiment;

FIG. 14 shows a highly abstracted schematic view of a driving device according to the invention according to a thirteenth embodiment;

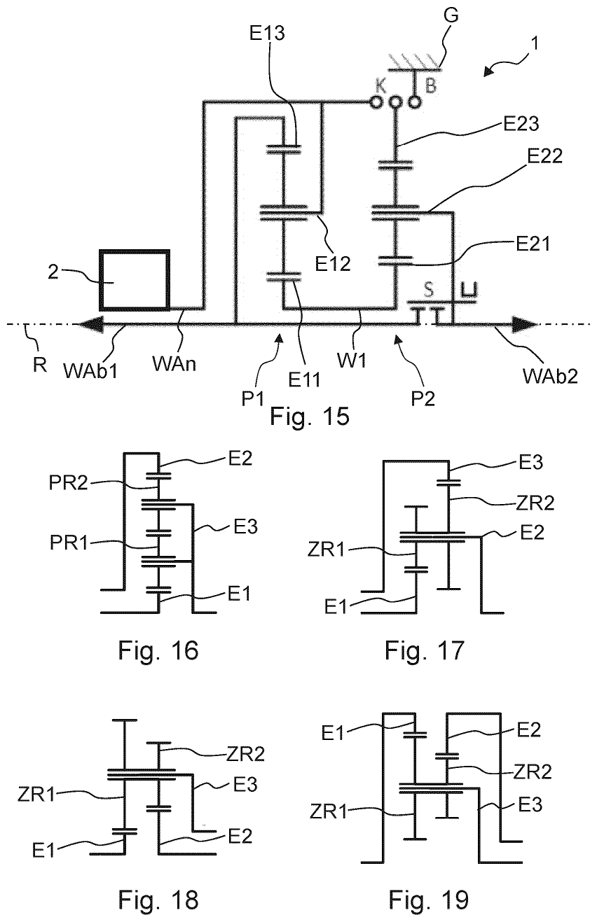

FIG. 15 shows a highly abstracted schematic view of a driving device according to the invention according to a fourteenth embodiment;

FIG. 16 shows a highly abstracted schematic view of a plus planetary gear set;

FIG. 17 shows a highly abstracted schematic view of a minus planetary gear set;

FIG. 18 shows a highly abstracted schematic view of a plus planetary gear set with two sun gears;

FIG. 19 shows a highly abstracted schematic view of a plus planetary gear set with two ring gears;

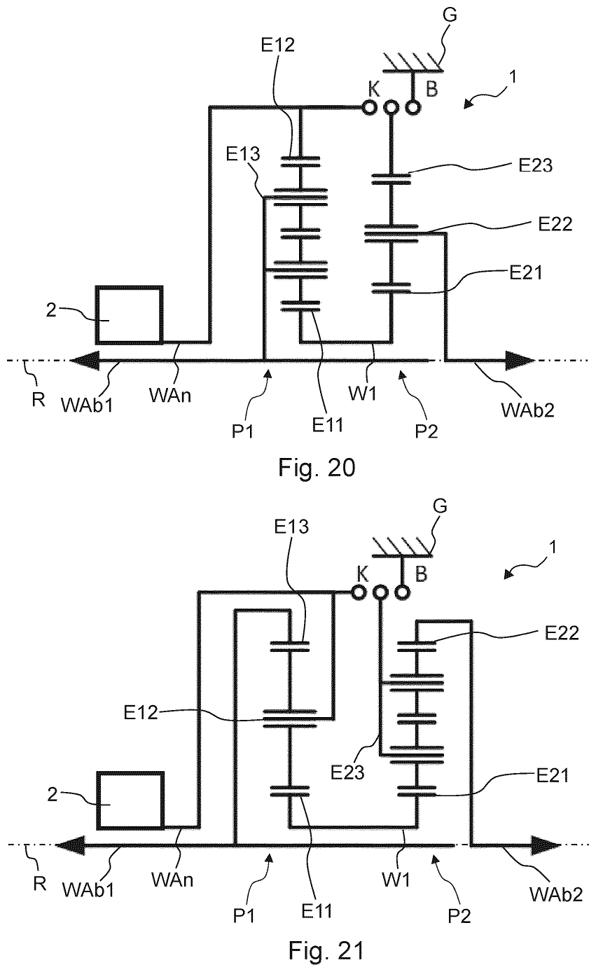

FIG. 20 shows a highly abstracted schematic view of a driving device according to the invention according to a fifteenth embodiment;

FIG. 21 shows a highly abstracted schematic view of a driving device according to the invention according to a sixteenth embodiment;

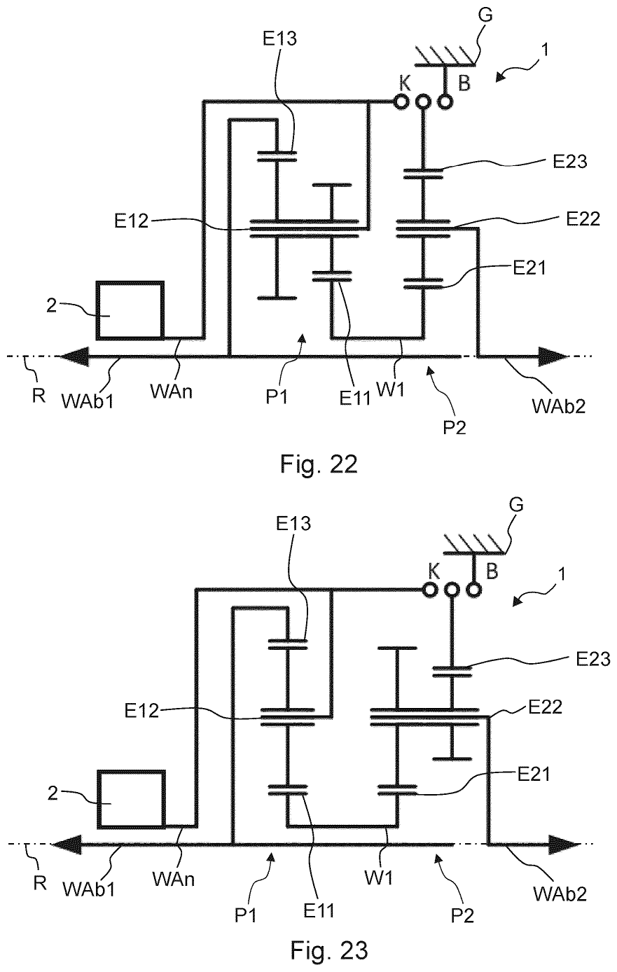

FIG. 22 shows a highly abstracted schematic view of a driving device according to the invention according to a seventeenth embodiment; and

FIG. 23 shows a highly abstracted schematic view of a driving device according to the invention according to an eighteenth embodiment.

FIG. 1 shows a motor vehicle 100 with a first wheel axle 101 with two wheels R1, R2 and a second wheel axle 102 with two wheels R3, R4. In the present case, the first wheel axle 101 is configured as a rear drive axle of the motor vehicle 100 and is equipped with a driving device according to the invention which comprises a driving machine 2 configured as an electric machine and a transmission 1 configured as an epicyclic gear transmission. Thus, the motor vehicle 100 is configured as an electric vehicle. The driving device is arranged transversely to the longitudinal direction of the vehicle and is drive-effectively connected to the wheels R1, R2 of the first wheel axle 101. Alternatively and not shown here, the driving device may be arranged in the longitudinal direction of the motor vehicle 100, wherein the transmission 2 is then not configured as a transverse differential but as a longitudinal differential. In the present case, no further driving device is arranged on the second wheel axle 102, i.e. on the front axle of the motor vehicle 100, whereby costs, weight and installation space are saved. Alternatively, instead of being arranged on the rear axle, the driving device may also be arranged on the front axle of the motor vehicle 100. To realize an all-wheel drive system, a further driving device may be arranged on the second wheel axle 102 and be drive-effectively connected to the wheels R3, R4 of this wheel axle 102.

FIG. 2 schematically shows the driving device from FIG. 1 with a transmission 1 according to the invention according to a first embodiment. The transmission 1 comprises a first planetary gear set P1 and a second planetary gear set P2, wherein each of the two planetary gear sets P1, P2 comprises a first element E11, E21, a second element E12, E22 and a third element E13, E23. In the present case, the first element E11, E21 of the respective planetary gear set P1, P2 is configured as a sun gear, wherein the second element E12, E22 of the respective planetary gear set P1, P2 is configured as a planet carrier, wherein the third element E13, E23 of the respective planetary gear set P1, P2 is configured as a ring gear. Each planet carrier carries a plurality of planet gears which are in meshing engagement with the sun gear and the ring gear of the respective planetary gear set P1, P2. Thus, both planetary gear sets P1, P2 are configured as conventional minus planetary gear sets. Alternatively, at least one of the two planetary gear sets P1, P2 may be configured as a conventional plus planetary gear set, minus stepped planetary gear set, plus stepped planetary gear set with two sun gears or plus stepped planetary gear set with two ring gears. In this regard, reference is made to FIG. 16 through FIG. 19.

The first planetary gear set P1 and the second planetary gear set P2 are arranged axially next to one another. As a result, the driving device is configured to be particularly compact, in particular in the axial direction. The connection of the driving machine 2 takes place laterally next to the first planetary gear set P1. According to an axial order, the first planetary gear set P1 is arranged axially on the driving machine 2, wherein the second planetary gear set P2 is arranged axially on the first planetary gear set P1. The two planetary gear sets P1, P2 form an integral differential.

On the basis of two minus planetary gear sets, the stationary transmission ratio of the first planetary gear set P1, viewed in absolute terms, is preferably greater by approximately one than the stationary transmission ratio of the second planetary gear set P2. This criterion permits a uniform distribution of the output torques between the two output shafts. Thus, for example, a transmission ratio of 1.5 may be achieved in that the first planetary gear set P1 comprises the stationary transmission ratio −3 and the second planetary gear set P2 comprises the stationary transmission ratio −2.

Furthermore, the transmission 1 comprises a drive shaft WAn for connecting the transmission 1 to the driving machine 2, a first output shaft WAb1 for connecting the transmission 1 to the first wheel R1 of the motor vehicle 100, a second output shaft WAb2 for connecting the transmission 1 to a second wheel R2 of the motor vehicle 100 as well as a coupling shaft W1 which connects the first element E11 of the first planetary gear set P1 and the first element E21 of the second planetary gear set P2 in a rotationally fixed manner. The coupling shaft W1 is configured as a double sun gear shaft. The first output shaft WAb1 may extend axially through both planetary gear sets P1, P2, wherein both sun gear shafts of the planetary gear sets P1, P2 are then configured as hollow shafts. For example, the coupling shaft W1 and the first output shaft WAb1 may be rotatably mounted on one another.

The drive shaft WAn is connected in a rotationally fixed manner to the second element E12 of the first planetary gear set P1. The first output shaft WAb1 is connected in a rotationally fixed manner to the third element E13 of the first planetary gear set P1. The second output shaft WAb2 is connected in a rotationally fixed manner to the second element E22 of the second planetary gear set P2. The third element E23 of the second planetary gear set P2 is connected in a rotationally fixed manner to a stationary component configured as a housing G.

In the present case, the drive shaft WAn is drivingly connected to the driving machine 2. For example, further elements, in particular a constant or a switchable transmission stage, may be arranged in the power flow between the driving machine 2 and the drive shaft WAn. For example, a switching element may be arranged between the driving machine 2 and the drive shaft WAn such that a power flow between the driving machine 2 and the drive shaft WAn is interrupted in order to decouple the driving machine 2 from the transmission 1.

The two planetary gear sets P1, P2 are arranged on a common rotation axis R. The driving machine 2 may be arranged coaxially or axially parallel to the rotation axis R. The respective output shaft WAb1, WAb2 is preferably connected in a rotationally fixed manner to a respective wheel of the motor vehicle, wherein this is indicated in a simplified manner by a respective arrow on the respective output shaft WAb1, WAb2. The two output shafts WAb1, WAb2 are also arranged on the common rotation axis R.

The transmission 1 has a good efficiency and is configured to be lightweight, compact and cost-effective.

FIG. 3 shows a second embodiment of the driving device according to the invention. The driving device according to FIG. 3 substantially corresponds to the driving device according to FIG. 2, wherein there is a difference between these two embodiments in the arrangement of a first switching element B and a second switching element K for switching of two different transmission ratios. The first switching element B is configured for switching of a first transmission ratio and the second switching element K is configured for switching of a second transmission ratio.

The first switching element B, in a closed state, connects the third element E23 of the second planetary gear set P2 in a rotationally fixed manner to a stationary component configured as a housing G. The second switching element K, in a closed state, connects the third element E23 of the second planetary gear set P2 in a rotationally fixed manner to the drive shaft WAn. The switching elements B, K are arranged radially stacked with the second planetary gear set P2, wherein the second planetary gear set P2 is arranged radially within the switching elements B, K and at least partially axially overlaps them. Moreover, it is preferred to arrange the switching elements B, K axially next to one of the two planetary gear sets P1, P2. As a result, their diameter may be reduced and the switching elements B, K may be configured to be more cost-effective and lighter.

When the first switching element B is closed and the second switching element K is open, a first transmission ratio is set. When the first switching element B is open and the second switching element K is closed, a second transmission ratio is set. The first transmission ratio and the switching positions of the two switching elements B, K connected therewith correspond to a first forward gear. The second transmission ratio and the switching positions of the two switching elements B, K connected therewith correspond to a second forward gear. In the present case, a step jump of approximately 1.4 to approximately 1.6 is possible.

Both switching elements K, B are configured as positively locking switching elements, in particular as dog clutches. The first switching element B and the second switching element K are combined to form a double switching element and may be actuated by means of a single actuator, which is not shown here.

Otherwise, the exemplary embodiment according to FIG. 3 corresponds to the exemplary embodiment according to FIG. 2, to which reference is made.

FIG. 4 shows a third embodiment of the driving device according to the invention. The driving device according to FIG. 4 substantially corresponds to the driving device according to FIG. 2, wherein there is a difference between these two embodiments in the arrangement of the two planetary gear sets P1, P2. In other words, all connections remain identical in this arrangement variant, wherein the position of the two planetary gear sets P1, P2, which in the present case have exchanged the sides in the transmission 1, also changes due to the different position of the connection to the housing G. According to an axial order, the second planetary gear set P2 is arranged axially on the driving machine 2, wherein the first planetary gear set P1 is arranged axially on the second planetary gear set P2. Depending on design boundary conditions, this arrangement variant may be advantageous with respect to the embodiment according to FIG. 2. Otherwise, the exemplary embodiment according to FIG. 4 corresponds to the exemplary embodiment according to FIG. 2, to which reference is made.

FIG. 5 shows a fourth embodiment of the driving device according to the invention. The driving device according to FIG. 5 substantially corresponds to the driving device according to FIG. 3, wherein there is a difference between these two embodiments in the arrangement of the two planetary gear sets P1, P2. In other words, all connections remain identical in this arrangement variant, wherein the position of the two switching elements B, K and the position of the two planetary gear sets P1, P2, which in the present case have exchanged the sides in the transmission 1, also change due to the different position of the connection to the housing G. According to an axial order, the second planetary gear set P2 is arranged axially on the driving machine 2, wherein the first planetary gear set P1 is arranged axially on the second planetary gear set P2. The switching elements B, K are arranged radially stacked with the second planetary gear set P2, wherein the second planetary gear set P2 is arranged radially within the switching elements B, K and at least partially axially overlaps them. Depending on design boundary conditions, this arrangement variant may be advantageous with respect to the embodiment according to FIG. 3. Otherwise, the exemplary embodiment according to FIG. 5 corresponds to the exemplary embodiment according to FIG. 3, to which reference is made.

FIG. 6 shows a fifth embodiment of the driving device according to the invention. The driving device according to FIG. 6 substantially corresponds to the driving device according to FIG. 3, wherein there is a difference between these two embodiments in the design of the two switching elements B, K. In the present case, the two switching elements B, K are not configured as positively locking switching elements, but as frictionally locking switching elements. Frictionally locking switching elements permit powershifts without interruption of tractive force. For example, a frictionally locking switching element may comprise one or more friction surfaces acting in parallel. Alternatively, the frictionally locking switching element may comprise one or more friction surfaces of conical configuration. In the present case, the frictionally locking switching elements B, K are configured as multiplate clutches. Alternatively, the design of the switching elements as freewheels is also conceivable. The first switching element B and the second switching element K are combined to form a frictionally locking double switching element and may be actuated by means of at least one actuator, which is not shown here. Otherwise, the exemplary embodiment according to FIG. 6 corresponds to the exemplary embodiment according to FIG. 3, to which reference is made.

FIG. 7 shows a sixth embodiment of the driving device according to the invention. The driving device according to FIG. 7 substantially corresponds to the driving device according to FIG. 3, wherein there is a difference between these two embodiments in the arrangement of the connection of the driving machine 2. In the present case, the connection of the driving machine 2 takes place axially between the first planetary gear set P1 and the second planetary gear set P2. As a result, the driving device is configured to be more compact in the axial direction. In particular, the position of the connection of the driving machine 2 may be selected on the basis of the installation space situation. The driving machine 2 may be arranged coaxially or axially parallel to the rotation axis R. Otherwise, the exemplary embodiment according to FIG. 7 corresponds to the exemplary embodiment according to FIG. 3, to which reference is made.

FIG. 8 shows a seventh embodiment of the driving device according to the invention. The driving device according to FIG. 8 substantially corresponds to the driving device according to FIG. 3, wherein there is a difference between these two embodiments in the arrangement of a constant transmission stage in the power flow between the driving machine 2 and the drive shaft WAn and thus before the first planetary gear set P1. In the present case, this transmission stage is configured as a third planetary gear set P3 and comprises a first element E31 configured as a sun gear, a second element E32 configured as a planet carrier and a third element E33 configured as a ring gear. Thus, the transmission stage is configured as a conventional minus planetary gear set. The first element E31 of the third planetary gear set P3 is connected in a rotationally fixed manner to a rotor shaft RW of the driving machine 2. The second element E32 of the third planetary gear set P3 is connected in a rotationally fixed manner to the drive shaft WAn. The third element E33 of the third planetary gear set P3 is connected in a rotationally fixed manner to the stationary component configured as a housing G. Alternatively, the connection of the third planetary gear set P3 may also be different, wherein one of the elements E31, E32, E33 of the third planetary gear set P3 is connected in a rotationally fixed manner to the housing G, another of the elements E31, E32, E33 of the third planetary gear set P3 is drivingly connected or connectable to the driving machine 2, i.e. indirectly or directly, and wherein another of the elements E31, E32, E33 of the third planetary gear set P3 is connected in a rotationally fixed manner to the drive shaft WAn. It is advantageous with this pre-transmission configured as a planetary gear set that higher transmission ratios may be achieved with the transmission 1. Otherwise, the exemplary embodiment according to FIG. 8 corresponds to the exemplary embodiment according to FIG. 3, to which reference is made.

FIG. 9 shows an eighth embodiment of the driving device according to the invention. The driving device according to FIG. 9 substantially corresponds to the driving device according to FIG. 8, wherein there is a difference between these two embodiments in the design of the transmission stage. In the present case, the transmission stage comprises no planetary gears, but stepped planetary gears. Thus, the transmission stage is configured as a minus stepped planetary gear set. The first element E31 of the minus stepped planetary gear set is configured in the present case as a sun gear. The second element E2 of the minus stepped planetary gear set is configured in the present case as a planet carrier. The third element E3 of the minus stepped planetary gear set is configured as a ring gear. The planet carrier of the minus stepped planetary gear set guides a plurality of stepped planetary gears, each consisting of a first gear and a second gear, wherein the two gears are connected to one another in a rotationally fixed and one-piece manner. In the present case, the first gear of the stepped planetary gear has a larger diameter than the second gear of the stepped planetary gear. The first gear of the stepped planetary gear is in meshing engagement with the inner sun gear and the second gear of the stepped planetary gear is in meshing engagement with the outer ring gear. Otherwise, the exemplary embodiment according to FIG. 9 corresponds to the exemplary embodiment according to FIG. 8, to which reference is made.

FIG. 10 shows a ninth embodiment of the driving device according to the invention. The driving device according to FIG. 10 substantially corresponds to the driving device according to FIG. 3, wherein there is a difference between these two embodiments in the arrangement of a transmission stage in the power flow between the driving machine 2 and the drive shaft WAn and thus before the first planetary gear set P1. In the present case, this transmission stage is provided as a spur gear stage ST and comprises a first gear Z1, which is connected in a rotationally fixed manner to a rotor shaft RW of the driving machine 2, and a second gear Z2, which is connected in a rotationally fixed manner to the drive shaft WAn. An axle distance of the driving machine 2 from the rotation axis R may be set via the diameters of the two gears Z1, Z2 of the spur gear stage ST. Thus, the driving machine 2 and the rotor shaft RW are arranged axially parallel to the drive shaft WAn and the two output shafts WAb1, WAb2. It is advantageous with this pre-transmission provided as a spur gear stage ST that higher transmission ratios may be achieved with the transmission 1. Otherwise, the exemplary embodiment according to FIG. 10 corresponds to the exemplary embodiment according to FIG. 3, to which reference is made.

FIG. 11 shows a tenth embodiment of the driving device according to the invention. The driving device according to FIG. 11 substantially corresponds to the driving device according to FIG. 10, wherein there is a difference between these two embodiments in the design of the transmission stage. In the present case, the transmission stage comprises a first spur gear stage ST1, a second spur gear stage ST2 and an intermediate shaft ZW arranged therebetween, wherein the intermediate shaft ZW has two toothed portions ZW1, ZW2. The first spur gear stage ST1 comprises a first gear Z1, which is connected in a rotationally fixed manner to the rotor shaft RW of the driving machine 2, and the first toothed portion ZW1 on the intermediate shaft ZW, which may be provided, for example, as a gear connected in a rotationally fixed manner to the intermediate shaft ZW. Thus, the first gear Z1 and the first toothed portion ZW1 on the intermediate shaft ZW are in meshing engagement with one another. The second spur gear stage ST2 comprises a second gear Z2, which is connected in a rotationally fixed manner to the drive shaft WAn, and the second toothed portion ZW2 on the intermediate shaft ZW, which may be provided, for example, as a gear connected in a rotationally fixed manner to the intermediate shaft ZW. Thus, the second gear Z2 and the second toothed portion ZW2 on the intermediate shaft ZW are in meshing engagement with one another. An axle distance of the driving machine 2 from the rotation axis R may be set via the diameters of the two gears Z1, Z2 and via the diameters of the two toothed portions ZW1, ZW2 on the intermediate shaft ZW. The driving machine 2 and the rotor shaft RW are arranged axially parallel to the intermediate shaft ZW and axially parallel to the drive shaft WAn. It is advantageous with this transmission stage configured as a pre-transmission that even higher transmission ratios may be achieved with the transmission 1. Otherwise, the exemplary embodiment according to FIG. 11 corresponds to the exemplary embodiment according to FIG. 10, to which reference is made.

FIG. 12 shows an eleventh embodiment of the driving device according to the invention. The driving device according to FIG. 12 substantially corresponds to the driving device according to FIG. 3, wherein there is a difference between these two embodiments in the arrangement of a transmission stage in the power flow between the driving machine 2 and the drive shaft WAn and thus before the first planetary gear set P1. In the present case, this transmission stage is provided as a bevel gear stage KST and comprises a first bevel gear K1, which is connected in a rotationally fixed manner to the rotor shaft RW, and a second bevel gear K2, which is connected in a rotationally fixed manner to the drive shaft WAn. It is advantageous with this pre-transmission provided as a bevel gear stage KST that higher transmission ratios may be achieved with the transmission 1. In particular, the configuration of the pre-transmission as a bevel gear stage KST is advantageous in a longitudinal installation of the driving machine 2 in the vehicle. Otherwise, the exemplary embodiment according to FIG. 12 corresponds to the exemplary embodiment according to FIG. 3, to which reference is made.

FIG. 13 shows a twelfth embodiment of the driving device according to the invention. The driving device according to FIG. 13 substantially corresponds to the driving device according to FIG. 8, wherein there is a difference between these two embodiments in the arrangement of two further switching elements S1, S2 and in the design of the switching elements B, K as frictionally locking switching elements. In the present case, the two switching elements S1, S2 are arranged in the power flow between the driving machine 2 and the drive shaft WAn and are configured as frictionally locking switching elements, for example as multiplate clutches, whereby a powershift is made possible. In particular, the switching element S1 and the switching element S2 are combined to form a double switching element. In a closed state of the switching element S1 and an open state of the switching element S2, the third element E33 of the third planetary gear set P3 is connected in a rotationally fixed manner to the stationary component configured as a housing G and, as a result, a first transmission ratio is set at the third planetary gear set P3. In an open state of the switching element S1 and a closed state of the switching element S2, the third planetary gear set P3 is blocked in that the first element E31 of the third planetary gear set P3 and the third element E33 of the third planetary gear set P3 are connected in a rotationally fixed manner and, as a result, a second transmission ratio is set at the third planetary gear set P3. Alternatively, the sun gear or the planet carrier may also be fixed to the housing G via the switching element S1. The achievement of a higher spread or smaller gear steps may be advantageous with an upstream 2-gear assembly. Furthermore, high transmission ratios at a high final speed may be achieved as a result.

Furthermore, in the present combination with the switching elements B, K, not only two gear stages, but a total of four gear stages are made possible. For example, for switching of a first gear stage, the switching elements B and S1 are closed, wherein the switching elements K and S2 are open. For example, for switching of a second gear stage, the switching elements K and S1 are closed, wherein the switching elements B and S2 are open. For example, for switching of a third gear stage, the switching elements B and S2 are closed, wherein the switching elements K and S1 are open. For example, for switching of a fourth gear stage, the switching elements K and S2 are closed, wherein the switching elements B and S1 are open. According to an embodiment not shown, the switching elements B and K may be omitted, whereby only two gear stages may be realized, namely a first gear stage, when switching element S1 is closed and switching element S2 is open, and a second gear stage, when switching element S2 is closed and switching element S1 is open. Otherwise, the exemplary embodiment according to FIG. 13 corresponds to the exemplary embodiment according to FIG. 8, to which reference is made.

FIG. 14 shows a thirteenth embodiment of the driving device according to the invention. The driving device according to FIG. 14 substantially corresponds to the driving device according to FIG. 3, wherein there is a difference between these two embodiments in the arrangement of a switching element S for generating a blocking effect between the two output shafts WAb1, WAb2. In the present case, this switching element S is configured as a frictionally locking switching element, such that it generates a torque between the two output shafts WAb1, WAb2 in a partially closed state. In a completely closed state of the switching element S, the two output shafts WAb1, WAb2 are connected to one another in a rotationally fixed manner via the switching element S. In a completely open state of the switching element S, no torque is trans-mitted via the switching element S between the two output shafts WAb1, WAb2. For example, the switching element S may comprise one or more friction surfaces acting in parallel. Alternatively, the switching element S may comprise one or more friction surfaces of conical configuration. A transmission 1 with such a blocking differential in particular permits sporty driving. According to an embodiment not shown, the switching elements B and K may also be omitted. Otherwise, the exemplary embodiment according to FIG. 14 corresponds to the exemplary embodiment according to FIG. 3, to which reference is made.

FIG. 15 shows a fourteenth embodiment of the driving device according to the invention. The driving device according to FIG. 15 substantially corresponds to the driving device according to FIG. 3, wherein there is a difference between these two embodiments in the arrangement of a switching element S for generating a blocking effect between the two output shafts WAb1, WAb2. In the present case, this switching element S is configured as a form-fitting switching element with an open and a closed shifting state. In a closed state of the switching element S, the two output shafts WAb1, WAb2 are connected to one another in a rotationally fixed manner via the switching element S. In an open state of the switching element S, no torque is trans-mitted via the switching element S between the two output shafts WAb1, WAb2, such that no blocking effect is present. For example, the switching element S may comprise a plurality of positively locking dogs. A transmission 1 with such a blocking differential in particular supports traction when driving off-road. According to an embodiment not shown, the switching elements B and K may also be omitted. Otherwise, the exemplary embodiment according to FIG. 15 corresponds to the exemplary embodiment according to FIG. 3, to which reference is made.

FIG. 16 to FIG. 19 show different configurations of planetary gear sets. At least one of the planetary gear sets P1, P2, P3 is configured either as a minus planetary gear set or as a plus planetary gear set and/or comprises stepped planetary gears. Thus, instead of being configured as a conventional minus planetary gear set, at least one of the planetary gear sets P1, P2, P3 of the transmission 1 according to the invention may be configured as a conventional plus planetary gear set, minus stepped planetary gear set, plus stepped planetary gear set with two sun gears or plus stepped planetary gear set with two ring gears.

FIG. 16 shows a plus planetary gear set. The first element E1 of the plus planetary gear set is configured as a sun gear, wherein the second element E2 of the plus planetary gear set is configured as a ring gear, and wherein the third element E3 of the plus planetary gear set is configured as a planet carrier. The planet carrier of the plus planetary gear set guides at least one planet gear pair, consisting of a first planet gear PR1 and a second planet gear PR2. The first planet gear PR1 is in meshing engagement with the inner sun gear and the second planet gear PR2 is in meshing engagement with the outer ring gear. Furthermore, the two planet gears PR1, PR2 of a planet gear pair are also in meshing engagement with one another.

FIG. 17 shows a minus stepped planetary gear set. The first element E1 of the minus stepped planetary gear set is configured in the present case as a sun gear and may alternatively be configured as a ring gear. The third element E3 of the minus stepped planetary gear set is configured as a ring gear and may, if the first element E1 of the minus stepped planetary gear set is a ring gear, be configured as a sun gear. The second element E2 of the minus stepped planetary gear set is configured in the present case as a planet carrier. The planet carrier of the minus stepped planetary gear set guides at least one stepped planetary gear, consisting of a first gear ZR1 and a second gear ZR2, wherein the two gears ZR1, ZR2 are connected to one another in a rotationally fixed and one-piece manner. In the present case, the first gear ZR1 of the stepped planetary gear has a smaller diameter than the second gear ZR2 of the stepped planetary gear. Alternatively, the first gear ZR1 of the stepped planetary gear may comprise a larger diameter than the second gear ZR2 of the stepped planetary gear. The first gear ZR1 of the stepped planetary gear is in meshing engagement with the inner sun gear and the second gear ZR2 of the stepped planetary gear is in meshing engagement with the outer ring gear.

FIG. 18 shows a plus stepped planetary gear set with two sun gears. The first element E1 of the plus stepped planetary gear set is configured as a first sun gear. The third element E3 of the plus stepped planetary gear set is configured as a planet carrier.

The second element E2 of the plus stepped planetary gear set is configured as a second sun gear. The planet carrier of the plus stepped planetary gear set guides at least one stepped planetary gear, consisting of a first gear ZR1 and a second gear ZR2, wherein the two gears ZR1, ZR2 are connected to one another in a rotationally fixed and one-piece manner. In the present case, the first gear ZR1 of the stepped planetary gear has a larger diameter than the second gear ZR2 of the stepped planetary gear. The first gear ZR1 of the stepped planetary gear is in meshing engagement with the first sun gear and the second gear ZR2 of the stepped planetary gear is in meshing engagement with the second sun gear.

FIG. 19 shows a plus stepped planetary gear set with two ring gears. The first element E1 of the plus stepped planetary gear set is configured as a first ring gear. The third element E3 of the plus stepped planetary gear set is configured as a planet carrier. The second element E2 of the plus stepped planetary gear set is configured as a second ring gear. The planet carrier of the plus stepped planetary gear set guides at least one stepped planetary gear, consisting of a first gear ZR1 and a second gear ZR2, wherein the two gears ZR1, ZR2 are connected to one another in a rotationally fixed and one-piece manner. In the present case, the first gear ZR1 of the stepped planetary gear has a larger diameter than the second gear ZR2 of the stepped planetary gear. The first gear ZR1 of the stepped planetary gear is in meshing engagement with the first ring gear and the second gear ZR2 of the stepped planetary gear is in meshing engagement with the second ring gear.

FIG. 20 shows a fifteenth embodiment of the driving device according to the invention. The driving device according to FIG. 20 substantially corresponds to the driving device according to FIG. 3, wherein there is a difference between these two embodiments in the design of the first planetary gear set P1 as a plus planetary gear set. Thus, the first planetary gear set P1 is configured as a plus planetary gear set, wherein the second planetary gear set P2 is configured as a minus planetary gear set. As already described in FIG. 16, the first element E11 of the plus planetary gear set is configured as a sun gear, wherein the second element E12 of the plus planetary gear set is configured as a ring gear, and wherein the third element E13 of the plus planetary gear set is configured as a planet carrier. Thus, the drive shaft WAn is connected in a rotationally fixed manner to the ring gear of the first planetary gear set P1, wherein the first output shaft WAb1 is connected in a rotationally fixed manner to the planet carrier of the first planetary gear set P1, wherein the second output shaft WAb2 is connected in a rotationally fixed manner to the planet carrier of the second planetary gear set P2, wherein the coupling shaft W1 connects the sun gear of the first planetary gear set P1 in a rotationally fixed manner to the sun gear of the second planetary gear set P2, wherein the first switching element B, in the closed state, connects the ring gear of the second planetary gear set P2 in a rotationally fixed manner to the housing G, wherein the second switching element K, in the closed state, connects the ring gear of the second planetary gear set P2 in a rotationally fixed manner to the drive shaft WAn. Otherwise, the exemplary embodiment according to FIG. 20 corresponds to the exemplary embodiment according to FIG. 3, to which reference is made.

FIG. 21 shows a sixteenth embodiment of the driving device according to the invention. The driving device according to FIG. 21 substantially corresponds to the driving device according to FIG. 3, wherein there is a difference between these two embodiments in the design of the second planetary gear set P2 as a plus planetary gear set. Thus, the first planetary gear set P1 is configured as a minus planetary gear set, wherein the second planetary gear set P2 is configured as a plus planetary gear set. As already described in FIG. 16, the first element E21 of the plus planetary gear set is configured as a sun gear, wherein the second element E22 of the plus planetary gear set is configured as a ring gear, and wherein the third element E23 of the plus planetary gear set is configured as a planet carrier. Thus, the drive shaft WAn is connected in a rotationally fixed manner to the planet carrier of the first planetary gear set P1, wherein the first output shaft WAb1 is connected in a rotationally fixed manner to the ring gear of the first planetary gear set P1, wherein the second output shaft WAb2 is connected in a rotationally fixed manner to the ring gear of the second planetary gear set P2, wherein the coupling shaft W1 connects the sun gear of the first planetary gear set P1 in a rotationally fixed manner to the sun gear of the second planetary gear set P2, wherein the first switching element B, in the closed state, connects the planet carrier of the second planetary gear set P2 in a rotationally fixed manner to the housing G, wherein the second switching element K, in the closed state, connects the planet carrier of the second planetary gear set P2 in a rotationally fixed manner to the drive shaft WAn. Otherwise, the exemplary embodiment according to FIG. 21 corresponds to the exemplary embodiment according to FIG. 3, to which reference is made.

The design of at least one of the two planetary gear sets P1, P2 as a plus planetary gear set is indeed more complex and also slightly worse in terms of efficiency, but may expand the realizable transmission ratio range. In particular, the configuration of the second planetary gear set as a plus planetary gear set may permit smaller transmission ratios or stepped steps. Both planetary gear sets P1, P2 may also be configured as plus planetary gear sets.

FIG. 22 shows a seventeenth embodiment of the driving device according to the invention. The driving device according to FIG. 22 substantially corresponds to the driving device according to FIG. 3, wherein there is a difference between these two embodiments in the design of the first planetary gear set P1 as a minus stepped planetary gear set. Thus, the first planetary gear set P1 is configured as a minus stepped planetary gear set, wherein the second planetary gear set P2 is configured as a minus planetary gear set. As already described in FIG. 17, the first element E11 of the minus stepped planetary gear set is configured as a sun gear, wherein the second element E12 of the minus stepped planetary gear set is configured as a planet carrier, and wherein the third element E13 of the minus stepped planetary gear set is configured as a ring gear. Thus, the drive shaft WAn is connected in a rotationally fixed manner to the planet carrier of the first planetary gear set P1, wherein the first output shaft WAb1 is connected in a rotationally fixed manner to the ring gear of the first planetary gear set P1, wherein the second output shaft WAb2 is connected in a rotationally fixed manner to the planet carrier of the second planetary gear set P2, wherein the coupling shaft W1 connects the sun gear of the first planetary gear set P1 in a rotationally fixed manner to the sun gear of the second planetary gear set P2, wherein the first switching element B, in the closed state, connects the ring gear of the second planetary gear set P2 in a rotationally fixed manner to the housing G, wherein the second switching element K, in the closed state, connects the ring gear of the second planetary gear set P2 in a rotationally fixed manner to the drive shaft WAn. Otherwise, the exemplary embodiment according to FIG. 22 corresponds to the exemplary embodiment according to FIG. 3, to which reference is made.

FIG. 23 shows an eighteenth embodiment of the driving device according to the invention. The driving device according to FIG. 23 substantially corresponds to the driving device according to FIG. 3, wherein there is a difference between these two embodiments in the design of the second planetary gear set P2 as a minus stepped planetary gear set. Thus, the first planetary gear set P1 is configured as a minus planetary gear set, wherein the second planetary gear set P2 is configured as a minus stepped planetary gear set. As already described in FIG. 17, the first element E21 of the minus stepped planetary gear set is configured as a sun gear, wherein the second element E22 of the minus stepped planetary gear set is configured as a planet carrier, and wherein the third element E23 of the minus stepped planetary gear set is configured as a ring gear. Thus, the drive shaft WAn is connected in a rotationally fixed manner to the planet carrier of the first planetary gear set P1, wherein the first output shaft WAb1 is connected in a rotationally fixed manner to the ring gear of the first planetary gear set P1, wherein the second output shaft WAb2 is connected in a rotationally fixed manner to the planet carrier of the second planetary gear set P2, wherein the coupling shaft W1 connects the sun gear of the first planetary gear set P1 in a rotationally fixed manner to the sun gear of the second planetary gear set P2, wherein the first switching element B, in the closed state, connects the ring gear of the second planetary gear set P2 in a rotationally fixed manner to the housing G, wherein the second switching element K, in the closed state, connects the ring gear of the second planetary gear set P2 in a rotationally fixed manner to the drive shaft WAn. Otherwise, the exemplary embodiment according to FIG. 23 corresponds to the exemplary embodiment according to FIG. 3, to which reference is made.

A design of at least one of the two planetary gear sets P1, P2 as a minus stepped planetary gear set is indeed more complex, but may expand the realizable transmission ratio range. If, for example, in the case of the first planetary gear set P1, a stationary transmission ratio which is particularly large in terms of absolute value is selected by means of the stepped planetary gears, the achievable transmission ratio range may be expanded in the direction of larger transmission ratios. If, for example, in the case of the second planetary gear set P2, a stationary transmission ratio which is particularly small in terms of absolute value is selected by means of the stepped planetary gears, the achievable transmission ratio range, analogously to the plus planetary gear set, may be expanded in the direction of smaller transmission ratios.

### REFERENCE SIGNS

1 transmission
2 driving machine
W1 coupling shaft
WAn drive shaft
RW rotor shaft
WAb1 first output shaft
WAb2 second output shaft
G housing
S switching element
B first switching element
K second switching element
S1 switching element
S2 switching element
R rotation axis
P1 first planetary gear set
E11 first element of the first planetary gear set
E12 second element of the first planetary gear set
E13 third element of the first planetary gear set
P2 second planetary gear set
E21 first element of the second planetary gear set
E22 second element of the second planetary gear set
E23 third element of the second planetary gear set
P3 third planetary gear set
E31 first element of the third planetary gear set
E32 second element of the third planetary gear set
E33 third element of the third planetary gear set
E1 first element
E2 second element
E3 third element
PR1 first planet gear
PR2 second planet gear
ZR1 first gear of the stepped planetary gear
ZR2 second gear of the stepped planetary gear
ST spur gear stage
Z1 first gear of the spur gear stage
Z2 second gear of the spur gear stage
ST1 first spur gear stage
ST2 second spur gear stage
ZW intermediate shaft
ZW1 first gear of the intermediate shaft
ZW2 second gear of the intermediate shaft
KST bevel gear stage
K1 first bevel gear
K2 second bevel gear
100 motor vehicle
101 first wheel axle
102 second wheel axle
R1 wheel
R2 wheel
R3 wheel
R4 wheel

1. A transmission (1) for a motor vehicle (100), comprising
a first planetary gear set (P1) and a second planetary gear set (P2), wherein each of the two planetary gear sets (P1, P2) comprising a first element (E11, E21), a second element (E12, E22) and a third element (E13, E23),
a drive shaft (WAn) for connecting the transmission (1) to a driving machine (2) of the motor vehicle (100),
a first output shaft (WAb1) and a second output shaft (WAb2) for respectively connecting the transmission (1) to a wheel (R1, R2) of the motor vehicle (100),
a coupling shaft (W1) which connects the first element (E11) of the first planetary gear set (P1) and the first element (E21) of the second planetary gear set (P2) in a rotationally fixed manner,
wherein the drive shaft (WAn) is connected in a rotationally fixed manner to the second element (E12) of the first planetary gear set (P1),
wherein the first output shaft (WAb1) is connected in a rotationally fixed manner to the third element (E13) of the first planetary gear set (P1),
wherein the second output shaft (WAb2) is connected in a rotationally fixed manner to the second element (E22) of the second planetary gear set (P2),
wherein the third element (E23) of the second planetary gear set (P2) is connected in a rotationally fixed manner to a stationary component.

2. A transmission (1) for a motor vehicle (100), comprising
a first planetary gear set (P1) and a second planetary gear set (P2), wherein each of the two planetary gear sets (P1, P2) comprising a first element (E11, E21), a second element (E12, E22) and a third element (E13, E23),
a drive shaft (WAn) for connecting the transmission (1) to a driving machine (2) of the motor vehicle (100),
a first output shaft (WAb1) and a second output shaft (WAb2) for respectively connecting the transmission (1) to a wheel (R1, R2) of the motor vehicle (100),
a coupling shaft (W1) which connects the first element (E11) of the first planetary gear set (P1) and the first element (E21) of the second planetary gear set (P2) in a rotationally fixed manner,
a first switching element (B) and a second switching element (K) for switching of two different transmission ratios,
wherein the drive shaft (WAn) is connected in a rotationally fixed manner to the second element (E12) of the first planetary gear set (P1),
wherein the first output shaft (WAb1) is connected in a rotationally fixed manner to the third element (E13) of the first planetary gear set (P1),
wherein the second output shaft (WAb2) is connected in a rotationally fixed manner to the second element (E22) of the second planetary gear set (P2),
wherein the third element (E23) of the second planetary gear set (P2) is connectable in a rotationally fixed manner to a stationary component via the first switching element (B) for setting a first transmission ratio,
wherein the third element (E23) of the second planetary gear set (P2) is connectable in a rotationally fixed manner to the drive shaft (WAn) via the second switching element (K) for setting a second transmission ratio.

3. The transmission (1) according to claim 2, wherein both switching elements (B, K) for switching of the two different transmission ratios are provided as positively locking or frictionally locking switching elements.

4. The transmission (1) according to claim 2 or 3, wherein the first switching element (B) and the second switching element (K) are provided as a double switching element.

5. The transmission (1) according to one of the preceding claims, wherein the connection of the driving machine (2) takes place axially between the first and second planetary gear set (P1, P2).

6. The transmission (1) according to one of claims 1 to 4, wherein the first and second planetary gear set (P1, P2) are arranged axially adjacent to one another and the connection of the driving machine (2) takes place laterally next to one of the planetary gear sets (P1, P2).

7. The transmission (1) according to one of the preceding claims, wherein at least one of the planetary gear sets (P1, P2) is provided either as a minus planetary gear set or as a plus planetary gear set and/or comprises stepped planetary gears.

8. The transmission (1) according to one of the preceding claims, wherein a switching element(S) for generating a blocking effect is arranged between the two output shafts (WAb1, WAb2).

9. The transmission (1) according to one of the preceding claims, further comprising a transmission stage provided as a planetary gear set (P3), which is arranged in the power flow before the first planetary gear set (P1).

10. The transmission (1) according to claim 9, wherein the transmission stage provided as a planetary gear set (P3) is configured to be switchable and comprises two switching elements (S1, S2).

11. The transmission (1) according to one of the preceding claims, further comprising a transmission stage provided as a spur gear stage (ST), which is arranged in the power flow before the first planetary gear set (P1).

12. The transmission (1) according to claim 11, wherein the transmission stage provided as a spur gear stage (ST) comprises an intermediate shaft (ZW).

13. The transmission (1) according to one of the preceding claims, further comprising a transmission stage provided as a bevel gear stage (KST), which is arranged in the power flow before the first planetary gear set (P1).

14. A driving device comprising an electric driving machine (2) and a transmission (1) according to one of claims 1 to 13, wherein the electric driving machine (2) is arranged coaxially or axially parallel to the transmission (1).

15. A motor vehicle (100) comprising a driving device according to claim 14.
